(19) United States
(12) Patent Application Publication
(10) Pub. No.: US 2013/0109037 A1
(43) Pub. Date: May 2, 2013

(54) METHODS FOR DETECTING ADENOSINE MONOPHOSPHATE IN BIOLOGICAL SAMPLES

(71) Applicant: PROMEGA CORPORATION, Madison, WI (US)

(72) Inventors: Said A. Goueli, Fitchburg, WI (US); Kevin Hsiao, Madison, WI (US); Hicham Zegzouti, Madison, WI (US)

(73) Assignee: PROMEGA CORPORATION, MADISON, WI (US)

(21) Appl. No.: 13/662,923

(22) Filed: Oct. 29, 2012

Related U.S. Application Data
(60) Provisional application No. 61/552,837, filed on Oct. 28, 2011.

(51) Int. Cl. G01N 21/76

(52) U.S. Cl. 435/8

(57) ABSTRACT

The present invention provides compositions and methods to detect and/or determine the amount and/or presence of adenosine monophosphate (AMP) in biological samples. The method comprises converting substantially all AMP in the solution to adenosine diphosphate (ADP) using a first enzyme, suitably polyphosphate:AMP phosphotransferase (PAP), that is capable of converting AMP to ADP; converting the ADP in the solution to adenosine triphosphate (ATP) using a second enzyme, suitably adenylate kinase (AK), that is capable of converting ADP to ATP; determining the amount of the ATP produced using a bioluminescent reaction utilizing a luciferase enzyme and a substrate for the luciferase enzyme; and using the amount of ATP produced to determine the amount of AMP present in the original solution.

### FIELD OF THE INVENTION

The present invention relates, in general, to cellular tools and, more particularly, to methods for detecting adenosine monophosphate (AMP) in biological samples.

### BACKGROUND OF THE INVENTION

Adenosine monophosphate (AMP) is an important intracellular mediator of a variety of cellular functions such as the control of the energy charge ratio within a cell, which is an important measurement for balancing anabolic and catabolic processes in the cell. It is also a product of ubiquitination reaction, protein synthesis and translation, nucleic acid ligations, phosphodiesterase activities, etc. Post-translational modifications of proteins by ubiquitin via ubiquitination, small ubiquitin-like modifier (SUMO) via sumoylation, ubiquitin-like protein Nedd8 via neddylation, etc. are key regulatory mechanisms functioning during a diversity of cellular processes such as cell cycle, transcription, nuclear transport, endocytosis, and protein quality control. The ubiquitin-proteasome system (UPS) is responsible for the degradation of many of the pivotal cell signaling molecules. The linkage type of the ubiquitin chain determines whether a modified protein is degraded by the proteasome or serves to attract proteins to initiate signaling cascades or be internalized. The process of ubiquitination is mediated by an enzymatic cascade initiated by ubiquitin activating enzyme (UAE known also as E1) using Adenosine Triphosphate (ATP), ubiquitin or its analogues, ubiquitin conjugating enzyme (Ube2 known also as E2), an ubiquitin ligase (E3) and a substrate to be ubiquitinated. The products of this ubiquitination cascade are AMP, pyrophosphate (PPᵢ), and an ubiquitinated (or polyubiquitinated) substrate. The processes of ubiquitination (or polyubiquitination) and deubiquitination are very attractive areas of research as evidenced by the FDA approval of a proteasome inhibitor VELCADE® for the treatment of patients with multiple myeloma and relapsed mantle cell lymphoma. Thus, targeting other components in the UPS pathway might represent an opportunity to develop novel anticancer therapeutics. Similar interest in the neurodegenerative research of Parkinson diseases identified Nedd4 as the E3 ligase which ubiquitinates alpha synuclein and targets it to the endosomal lysosomal pathway, thus reducing alpha synuclein content and protecting against the pathogenesis of Parkinson diseases and other alpha-synucleinopathies.

Protein translation requires the ligation of substrate amino acids to their cognate tRNAs with high fidelity. This process proceeds in two steps: the activation of amino acids to aminoacyladenylates via consumption of one molecule of ATP and the delivery of activated amino acids to the acceptor end of tRNAs. The fidelity of this process depends on the accuracy of the recognition of amino acids and their cognate tRNAs by aminoacyl tRNA synthase (ARS) and proofreading which prevents ligation of the wrong amino acid to the wrong tRNA. Proofreading occurs before the transfer of aminoacyl-AMP to tRNAs and results in the release of AMP. Thus, the translation of proteins requires a process that consumes ATP, and the release of AMP as the product. Phosphodiesterases (PDEs) are another example of enzymes that use cyclic adenosine 3,5,-monophosphate (cAMP) as a substrate and release AMP as the reaction product. These enzymes are involved in a variety of pathological disorders such as asthma, cardiovascular functions, neurodegenerative disease, etc.

DNA ligases catalyze the ligation of single-stranded breaks to complete DNA replication and repair via ATP breakdown resulting in the formation of a new phosphodiester bond in DNA. Eukaryotic DNA ligases use ATP as the adenylyl group donor, whereas bacterial DNA ligases use either ATP or nicotinamide adenine dinucleotide (NAD+). DNA ligases catalyze the nucleophilic attack of the 3′-hydroxyl on the adenylated 5′-phopshate to form a new phosphodiester bond and release AMP. Bacterial DNA ligases inhibition without affecting eukaryotic ligases or other DNA-binding enzymes have been successfully selected as novel strategy to develop novel antibacterial agents.

Other reactions involving DNA methyltransferases (DMT) and protein methyltransferases (PMT) show promise in the field of epigenetics and are currently under intensive investigation. These enzymes utilize S-adenosyl methionine (SAM) as a substrate, and the resulting product S-adenosylhomocysteine (SAH) can be hydrolyzed to adenosine by SAH hydrolase. The resulting product, adenosine, can be converted to AMP using adenosine kinase. Thus, monitoring AMP formation can be used as readout for DMT and PMT activities.

It was also reported that AMP concentration increases significantly in tumors under hypoxia as compared to wild type, and thus, an increase in the ratio of AMP to ATP causes the allosteric activation of phosphofructokinase-1 (PFK-1). Thus, tumors can maintain normal rate of glycolysis by running at a lower inhibitory ATP concentration and a much higher activating AMP concentration. The higher AMP concentration and lower ATP concentration in tumor cells also cause the activation of AMP-activated protein kinase which coordinates cellular proliferation with carbon source availability. The above examples highlight the significance of monitoring AMP concentrations in biochemical as well as cellular or tissue samples. Validating the targets as well as developing molecule(s) that can alter the biochemical process, which are involved in the development of abnormal cellular physiology, and inducing certain pathologies is dependent on the availability of robust and fast technologies. Thus, there is a need for assays that meet the requirements of a drug discovery program where quality, cost, and speed of the technical work is necessary. Such needs are not met in currently used assays, and thus the AMP detection method of the present invention fulfills theses unmet demands.

### SUMMARY OF THE INVENTION

The patent application provides methods and kits to for monitoring AMP in a variety of biochemical and cellular applications. The technology and the kits detect free AMP present in cell extract in the presence of other nucleotides and AMP produced in biochemical reactions such as Phosphodiesterase (PDE), enzymes involved in Ubiquitination (Ligases), amino acyl tRNA Synthetases (ARS), DNA ligases (both bacterial and eukaryotic DNA ligases, etc.

The kit can also detect AMP that is produced indirectly from biochemical reactions by converting their products into AMP and then detection of the newly formed AMP by the current assay format. These include DNA and protein methyltransferases, Protein Isoaspartyl Methyl Transferase (PIMT), etc.

In one embodiment, the invention provides a method of determining the amount of adenosine monophosphate (AMP) in an original solution by converting substantially all AMP in the solution to adenosine diphosphate (ADP) using a first enzyme that is capable of converting AMP to ADP. Suitably at least 90%, or at least 91% or at least 92%, or at least 93%, or at least 94%, or at least 95%, or at least 96%, or at least 97%, or at least 98%, or at least 99%, or at least 99.9% of the AMP in the original solution is converted by the first enzyme. This first enzyme is suitably polyphosphate:AMP phosphotransferase (PAP), but can be any other suitable enzyme. Polyphosphate may optionally be added along with the PAP. The ADP in the solution is then converted into adenosine triphosphate (ATP) using a second enzyme that is capable of converting ADP to ATP. This second enzyme is suitably adenylate kinase (AK), but can be any other suitable enzyme. The conversion of ADP to ATP can be either simultaneous with, or after, the conversion of the AMP to ADP by the first enzyme. The amount of ATP produced is determined by utilizing a luciferase enzyme and a substrate for the luciferase enzyme. Suitably the substrate for the luciferase enzyme is luciferin, but can be any other suitable substrate. The amount of ATP produced can then be used to determine the amount of AMP that was present in the original solution.

In another embodiment the invention provides a method of determining the amount of AMP in an original solution by first converting substantially all ATP in the original solution to cyclic adenosine monophosphate (cAMP) and pyrophosphate using adenylate cyclase (AC), and then converting substantially all AMP in the solution to ADP using a first enzyme that is capable of converting AMP to ADP. The AC can be an active fragment of a full length bacterial adenylate cyclase or an active recombinant fragment of a bacterial adenylate cyclase. Suitably the AC can be a bacterial adenylate cyclase, such as Bortedella pertussis or Bacillus anthracis. In certain embodiments, suitably at least 90%, or at least 91% or at least 92%, or at least 93%, or at least 94%, or at least 95%, or at least 96%, or at least 97%, or at least 98%, or at least 99%, or at least 99.9% of the ATP in the original solution is converted by AC. The first enzyme used to convert AMP to ADP is suitably PAP, but can be any other suitable enzyme. Polyphosphate may optionally be added along with the PAP. The ADP in the solution is then converted into ATP using a second enzyme that is capable of converting ADP to ATP. Optionally, before the conversion of ADP to ATP, a step of inhibiting the AC in the solution can be done by providing an AC inhibiting compound such as Calmidazolium to the solution. The second enzyme to convert the ADP to ATP is suitably AK, but can be any other suitable enzyme. The conversion of ADP to ATP can be either simultaneous with, or after, the conversion of the AMP to ADP by the first enzyme. The amount of ATP produced is determined by utilizing a luciferase enzyme and a substrate for the luciferase enzyme. Suitably the substrate for the luciferase enzyme is luciferin, but can be any other suitable substrate. The amount of ATP produced can then be used to determine the amount of AMP that was present in the original solution. Optionally, steps of removing substantially all of any pyrophosphate in the solution can be done by including a Pyrophospahatase before the conversion of ADP to ATP and/or before performing the bioluminescent reaction to determine the amount of ATP in the solution. In certain embodiments, suitably at least 90%, or at least 91% or at least 92%, or at least 93%, or at least 94%, or at least 95%, or at least 96%, or at least 97%, or at least 98%, or at least 99%, or at least 99.9% of the pyrophosphate is removed by the Pyrophospahatase.

In another embodiment, the invention provides a method of determining the amount of AMP in an original solution by converting a portion or substantially all cAMP in the original solution to AMP using a phosphodiesterase (PDE) and converting substantially all AMP in the solution to ADP using a first enzyme that is capable of converting AMP to ADP. The conversion of the cAMP to AMP can be before, or simultaneous with, the conversion of AMP to ADP. In certain embodiments, suitably at least 90%, or at least 91% or at least 92%, or at least 93%, or at least 94%, or at least 95%, or at least 96%, or at least 97%, or at least 98%, or at least 99%, or at least 99.9% of the cAMP in the original solution is converted by the PDE. Suitably, the PDE can be PDE 1, PDE 3, PDE 4, PDE 7, PDE 10A, PDE 11, or any other suitable PDE. The first enzyme to convert AMP to ADP is suitably PAP, but can be any other suitable enzyme. Polyphosphate may optionally be added along with the PAP. The ADP in the solution is then converted into ATP using a second enzyme that is capable of converting ADP to ATP. This second enzyme is suitably AK, but can be any other suitable enzyme. The conversion of ADP to ATP can be either simultaneous with, or after, the conversion of the AMP to ADP by the first enzyme. The amount of ATP produced is determined by utilizing a luciferase enzyme and a substrate for the luciferase enzyme. Suitably the substrate for the luciferase enzyme is luciferin, but can be any other suitable substrate. The amount of ATP produced can then be used to determine the amount of AMP that was present in the original solution.

In another embodiment, the invention provides a method of determining the amount of AMP in an original solution by first converting a portion or substantially all ATP present in the original solution to AMP using an ubiquitinating enzyme system (E1, E2, and E3 ligase) and ubiquitin, and then converting substantially all AMP in the solution to ADP using a first enzyme that is capable of converting AMP to ADP. In certain embodiments, suitably at least 90%, or at least 91% or at least 92%, or at least 93%, or at least 94%, or at least 95%, or at least 96%, or at least 97%, or at least 98%, or at least 99%, or at least 99.9% of the ATP in the original solution is converted by the ubiquitinating enzyme. The ubiquitinating enzyme is suitably Ube 1 (E1), UbcH5c (E2), CARP2 (E3), or any other suitable ubiquitinating enzyme. This first enzyme for conversion of AMP to ADP is suitably PAP, but can be any other suitable enzyme. Polyphosphate may optionally be added along with the PAP. Simultaneously, or before the conversion of AMP to ADP, substantially all ATP in the original solution can be converted to cAMP and pyrophosphate using adenylate cyclase (AC). The ADP formed by the first enzyme in the solution is then converted into ATP using a second enzyme that is capable of converting ADP to ATP. This second enzyme is suitably AK, but can be any other suitable enzyme. The conversion of ADP to ATP can be either simultaneous with or after the conversion of the AMP to ADP by the first enzyme. The amount of ATP produced is determined by utilizing a luciferase enzyme and a substrate for the luciferase enzyme. Suitably the substrate for the luciferase enzyme is luciferin, but can be any other suitable substrate. The amount of ATP produced can then be used to determine the amount of AMP that was present in the original solution. Optionally, steps of removing substantially all of any pyrophosphate in the solution can be done by including a Pyrophospahatase before the conversion of ADP to ATP and/or before performing the bioluminescent reaction to determine the amount of ATP in the solution.

In another embodiment, the invention provides a method of determining the amount of AMP in an original solution by first converting a portion or substantially all of any ATP present in the original solution to AMP using a DNA ligase, and them converting substantially all AMP in the solution to ADP using a first enzyme that is capable of converting AMP to ADP. In certain embodiments, suitably at least 90%, or at least 91% or at least 92%, or at least 93%, or at least 94%, or at least 95%, or at least 96%, or at least 97%, or at least 98%, or at least 99%, or at least 99.9% of the ATP in the original solution is converted using the DNA ligase. Optionally, the solution may also contain, or have added into it, nicotinamide adenine dinucleotide (NAD+) which is converted by the DNA ligase to AMP. This conversion of NAD+ can be before, or simultaneous with, the conversion of AMP to ADP. The DNA ligase is suitably either a eukaryotic or viral DNA ligase. When NAD+ is present a suitably DNA ligase may be an E. coli NAD+ dependant DNA ligase, or other suitable ligase. The first enzyme for conversion of AMP to ADP is suitably PAP, but can be any other suitable enzyme. Polyphosphate may optionally be added along with the PAP. Simultaneously, or before the conversion of AMP to ADP, substantially all ATP in the original solution can be converted to cAMP and pyrophosphate using adenylate cyclase (AC). The ADP formed by the first enzyme in the solution is then converted into ATP using a second enzyme that is capable of converting ADP to ATP. The ADP in the solution is then converted into ATP using a second enzyme that is capable of converting ADP to ATP. This second enzyme is suitably AK, but can be any other suitable enzyme. The conversion of ADP to ATP can be either simultaneous with or after the conversion of the AMP to ADP by the first enzyme. The amount of ATP produced is determined by utilizing a luciferase enzyme and a substrate for the luciferase enzyme. Suitably the substrate for the luciferase enzyme is luciferin, but can be any other suitable substrate. The amount of ATP produced can then be used to determine the amount of AMP that was present in the original solution. Optionally, steps of removing substantially all of any pyrophosphate in the solution can be done by including a Pyrophosphatase before the conversion of ADP to ATP and/or before performing the bioluminescent reaction to determine the amount of ATP in the solution.

In another embodiment, the invention provides a method of determining the amount of AMP in an original solution by converting S-adenosyl methionine (SAM) present in the solution to S-adenosylhomocysteine (SAH) using a methyltransferase; converting the SAH to adenosine using an SAH hydrolase; converting the adenosine to AMP using adenosine kinase; and converting substantially all AMP in the solution to ADP using a first enzyme that is capable of converting AMP to ADP. The conversion of SAM to SAH, SAH to adenosine, and adenosine to AMP can be done before, or simultaneous with, the conversion of AMP to ADP. The methyltransferase suitable can be histone-lysine N-methyltransferase, (DNA (cytosine-5)-methyltransferase, Protein Isoaspartate Methyl Transferase and protein arginine methyltransferase, or any other suitable methyltransferase. The first enzyme for conversion of AMP to ADP is suitably PAP, but can be any other suitable enzyme. Polyphosphate may optionally be added along with the PAP. The ADP in the solution is then converted into ATP using a second enzyme that is capable of converting ADP to ATP. This second enzyme is suitably AK, but can be any other suitable enzyme. The conversion of ADP to ATP can be either simultaneous with or after the conversion of the AMP to ADP by the first enzyme. The amount of ATP produced is determined by utilizing a luciferase enzyme and a substrate for the luciferase enzyme. Suitably the substrate for the luciferase enzyme is luciferin, but can be any other suitable substrate. The amount of ATP produced can then be used to determine the amount of AMP that was present in the original solution.

In another embodiment, the invention provides a method of determining the amount of AMP in an original solution by converting a portion of or substantially all of any ATP in the solution to AMP using an aminoacyl tRNA synthetase and then converting substantially all AMP in the solution to ADP using a first enzyme that is capable of converting AMP to ADP. In certain embodiments, suitably at least 90%, or at least 91% or at least 92%, or at least 93%, or at least 94%, or at least 95%, or at least 96%, or at least 97%, or at least 98%, or at least 99%, or at least 99.9% of the ATP in the original solution is converted using an aminoacyl tRNA synthetase. The first enzyme for conversion of AMP to ADP is suitably PAP, but can be any other suitable enzyme. Polyphosphate may optionally be added along with the PAP. The ADP in the solution is then converted into ATP using a second enzyme that is capable of converting ADP to ATP. This second enzyme is suitably AK, but can be any other suitable enzyme. The conversion of ADP to ATP can be either simultaneous with or after the conversion of the AMP to ADP by the first enzyme. The amount of ATP produced is determined by utilizing a luciferase enzyme and a substrate for the luciferase enzyme. Suitably the substrate for the luciferase enzyme is luciferin, but can be any other suitable substrate. The amount of ATP produced can then be used to determine the amount of AMP that was present in the original solution. Optionally, steps of removing substantially all of any pyrophosphate in the solution can be done by including pyrophosphatase before the conversion of ADP to ATP and/or before performing the bioluminescent reaction to determine the amount of ATP in the solution.

In another embodiment, the invention provides a kit for measuring the amount of AMP in solution comprising: polyphosphate:AMP phosphotransferase (PAP); polyphosphate, adenylate kinase (AK), a luciferase enzyme, and a substrate for a luciferase enzyme. In kit can optionally also contain any or all of the following components: adenylate cyclase (AC), pyrophosphatase (PPase), magnesium chloride, calmodulin, ATP, AMP, isobutylmethylxanthine (IBMX), or an aminoacyl tRNA synthetase. The kit may also contain a phosphodiesterase (PDE). In one embodiment the PDE may be PDE 1, PDE 3, PDE 4, PDE 7, PDE 10A or PDE 11. The kit may also contain a ubiquitinating enzyme and ubiquitin. In one embodiment the ubiquitinating enzyme may be Ube 1 (E1), UbcH5c (E2) or CARP2 (E3). The kit may also contain a DNA ligase. In one embodiment the DNA ligase is an E. coli DNA ligase. The kit may also contain nicotinamide adenine dinucleotide (NAD+), and optionally an E. coli NAD+ dependant DNA ligase. The kit may also contain an SAH dydrolase, adenosine kinase, and a methyltransferase. In one embodiment the methyltransferase may be histone-lysine N-methyltransferase, (DNA (cytosine-5)-methyltransferase, Protein Isoaspartate Methyl Transferase or protein arginine methyltransferase.

### BRIEF DESCRIPTION OF THE DRAWINGS

FIG. 1 shows a scheme of the AMP detection assay described in the present invention.

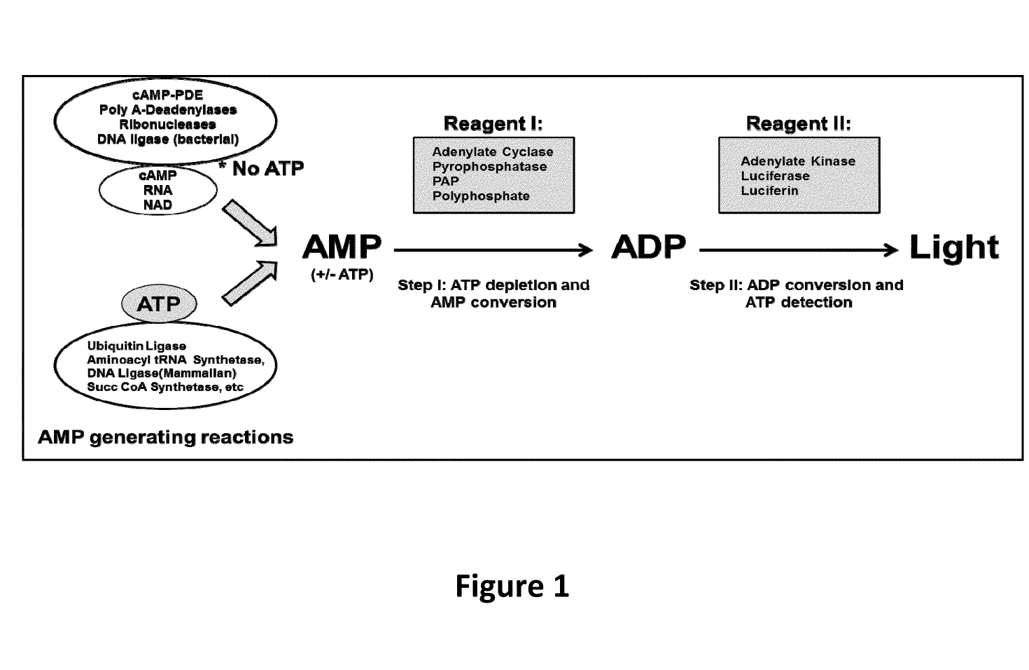

FIG. 2 illustrates the linearity of AMP detection in the presence or absence of ATP using the method and compositions of the present invention as described in Example 1.

FIG. 3 shows a titration of E3 Ligase CARP2 using 100 μM ATP and 40 μM ubiquitin in the presence of 150 nM E1 and 600 nM E2. E3 ligase activity determined using the methods and compositions of the present invention as described in Example 2.

FIG. 4 shows a titration of various cAMP Phopshodiesterases. The detection of cAMP PDE activities was carried out using the methods and compositions of the present invention in one or two step assay as described in Example 3.

FIG. 5 shows a titration of various inhibitors against PDE 3B using the methods and compositions of the present invention as described in Example 3.

FIG. 6 shows a T4 DNA ligase titration detected using the methods and compositions of the present invention as described in Example 4.

FIG. 7 shows the specificity of E. coli DNA ligase towards various nicotinamide substrates demonstrated using the methods and compositions of the present invention as described in Example 4.

FIG. 8 shows a scheme of the AMP detection assay applied to SAH detection for different Methyltransferase activity determinations described in the present invention.

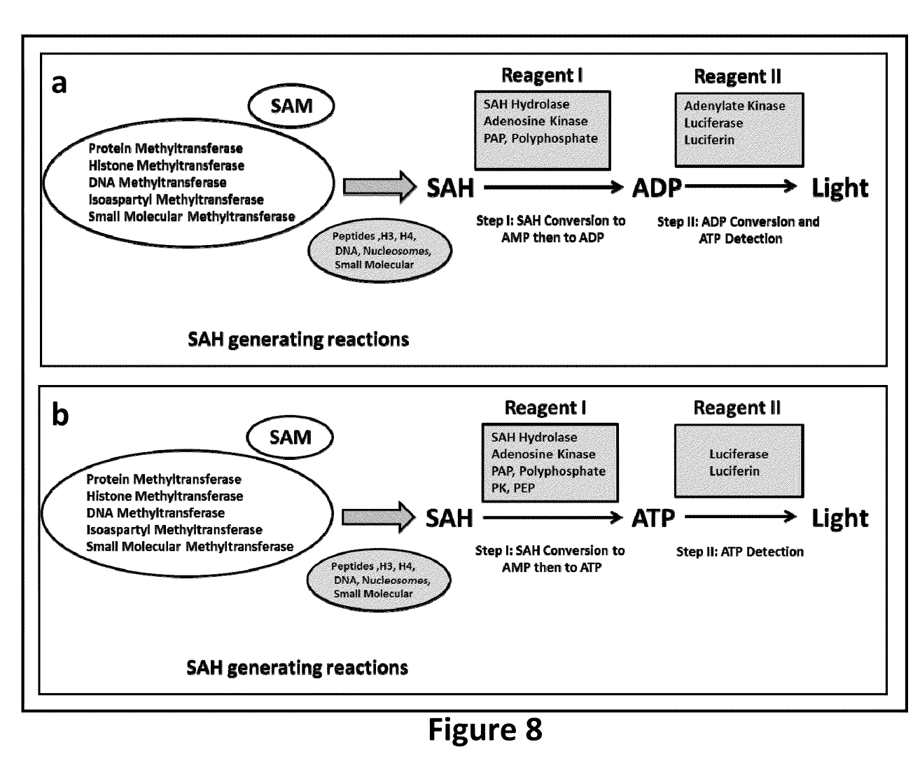

FIG. 9 shows a determination of various methyltransferase enzyme activities using the methods and compositions of the present invention as described in Example 6. The invention was used to detect the activity of A) Lysine Methyltransferase (EHMT2-G9a), B) Arginine Methyltransferase (PRMT5), and C) DNA Methyltransferase (DNMT1).

FIG. 10 shows a titration of the lysine methyltransferase, EHMT2-G9a, using different substrates and the methods and compositions of the present invention as described in Example 6.

### DETAILED DESCRIPTION OF THE INVENTION

The present invention provides compositions and methods to detect and/or determine the amount and/or presence of adenosine monophosphate (AMP) in biological samples. The present invention also provides compositions and methods to detect or determine the activity of various enzymes, e.g., phosphodiesterases (PDEs), ubiquitin and ubiquitin-like activating enzymes (E1), ubiquitin and ubiquitin-like conjugating enzymes (E2), ubiquitin and ubiquitin-like ligases (E3), DNA ligases, aminoacyl tRNA synthetases (ARS), DNA methyltransferases (DMT) and protein methyltransferases (PMTS), protein isoaspartate methyltransferases, etc. and by detecting and/or determining the amount of AMP in a biological sample. The present invention may also be used to detect AMP in a mixture containing other nucleotides such as adenosine diphosphate (ADP), adenosine triphosphate ATP, guanosine triphosphate (GTP), etc. The method of the present invention can be used to detect or determine the amount of AMP in pure biochemical enzymatic reactions or in a sample of cellular or tissue extracts.

The present invention also provides compositions and kits used to detect AMP in any sample that may contain AMP such as extracts of cells or tissues, fluid samples such as urine or blood, or biochemical enzymatic reactions involving purified enzymes such as PDEs, ARS, ubiquitin or DNA ligases, etc. The composition and kits of the invention contain an enzyme that removes or depletes substantially all the ATP present in the sample or remains after completion of the enzymatic reaction. In some embodiments, the compositions and kits of the present invention include adenylate cyclase (AC), polyphosphate:AMP phosphotransferase (PAP), pyrophosphatase (PPase), adenylate kinase (AK), polyphosphate, luciferin and luciferase (Luc). In other embodiments, the compositions and kits of the present invention may also contain an enzyme(s) that converts AMP to ADP and a substrate(s) for this enzyme. In some embodiments, the compositions and kits of the present invention may also include an enzyme(s) that converts ADP to ATP, and an enzyme that converts ATP into a luminescent signal, i.e., luminescence, via a luciferin-luciferase reaction. In some embodiments, the compositions and kits of the present invention may also contain buffer components and substrates such as polyphosphates, magnesium and calmodulin which may be required for the activity of the enzymes present. In some embodiments, the compositions and kits of the present invention may also contain pyrophosphatase which breaks down pyrophosphate generated from enzymes such as adenylate cyclase (AC). In some embodiments, the components for the conversion of ADP to ATP and ATP detection, e.g., luciferin-luciferase reaction can be added separately or simultaneously. In some embodiments, the components for the removal or depletion of ATP and the conversion of AMP to ADP can be added separately or simultaneously.

In some embodiments, wherein methyltransferases such as DNA, protein, and small molecules methyltransferase activity is to be detected or determined, wherein the universal substrate is S-adenosylmethionine (SAM) and the universal product is S-adenosylhomocysteine (SAH), the product SAH is converted to AMP by enzymes such as S-adenosylhomocysteine hydrolase (SAHH) and adenosine kinase (AdK), and the substrate is GTP or dGTP. In some embodiments, the components and kit for detecting or determining methyltransferase activity additionally contains SAHH, AdK and GTP or dGTP. In some embodiments, the kit may also contain a standard for methyltransferases such as the substrate S-adenosylmethionine and/or SAH, a standard for monitoring product formation. In some embodiments, the components for the conversion of AMP to ADP, ADP to ATP and the ATP detection, e.g., luciferin-luciferase reaction can be added separately or simultaneously.

In some embodiments, the method of the present invention provides a two-step method, wherein in a first step, ATP is removed using adenylate cyclase (AC) (so minimal or no ATP remains) while simultaneously converting AMP present in the sample to ADP using polyphosphate:AMP phosphotransferase (PAP) and polyphosphates. In a second step, the ADP produced is converted to ATP using adenylate kinase (AK) while simultaneously detecting the ATP formed with an ATP-detection reagent containing luciferin and a luciferase to generate a luminescent signal, i.e., luminescence. The amount of luminescence generated is proportional to the amount of AMP produced in the first reaction. In some embodiments, the AMP detected correlates to the enzymatic activity of enzymes such as PDEs, ARS, DNA ligases, DNA or protein methyltransferases, or protein isoaspartate methyltransferases, or ubiquitin ligases in a sample.

In other embodiments, the method of the present invention can also be used to monitor AMP present in a sample containing ATP and other nucleotide triphosphates. It is noteworthy that in an AC reaction, which uses ATP as substrate, the cAMP generated has insignificant or no effect on the later reactions using AK and luciferase. Since GTP and CTP are the major nucleotide triphosphates in a cell or tissue extracts and biological samples, and both are poor substrates for firefly luciferases, minimal interference to luminescence will occur when these are present in a sample. Similar results can be also obtained when using other enzymes that convert ADP to ATP such as pyruvate kinase with a phosphoenolpyruvate substrate, creatine kinase with a phosphocreatine substrate, and polyphosphate kinase PPK. In some embodiments, an enzyme such as phosphopyruvate dikinase (PPDK) can be used to convert AMP directly to ATP in one step. This reaction, though, has been shown not to be tolerated by the luciferin-luciferase reaction reagents containing luciferase, luciferin, phosphates, detergents, antifoaming agents, etc.

The strength of the methods of the present invention lies in its simplicity, high sensitivity, robustness, no requirement for antibodies, and ease of use. Another advantage of the present invention is that it minimizes the concern over interference from fluorescent compounds and/or other chemicals since the luciferin-luciferase reaction reagent formulation contains a high concentration of luciferin thus minimizing the effect of luciferin chemical analogues. Furthermore, the present invention makes use of polyphosphate, and not ATP, as a phosphate donor for both PAP and AK. This circumvents the problems that occur when using ATP as phosphate donor since ATP will interfere with the luciferin-luciferase reaction as ATP is a substrate for luciferase. Thus, the only source of luminescence is generated from AMP in the sample which is converted to ATP via PAP/AK combination. In some embodiments, the components necessary for the conversion of ADP to ATP and the luciferin-luciferase reaction can be added separately instead of being combined.

In some embodiments, the luciferase enzyme used in the luciferin-luciferase reaction is a beetle luciferase such as firefly luciferase, e.g., Photinus pyralis, Photuris pennsylvanica, etc., a recombinant form of a beetle luciferase, a mutant form of a beetle luciferase, e.g., one that is thermostable and/or chemostable, or any luciferase that uses ATP, luciferin, molecular oxygen, magnesium, or any other divalent cation, to generate luminescence can be used in the method of the present invention.

In some embodiments, the adenylate cyclase (AC) can be a recombinant active fragment of the pertussis toxin from Bortedella pertussis. In other embodiments, other sources of AC such as those from V. cholerae, e.g., cya, B. anthracis, mammalian adenylate cyclases and other sources can be used in the method of the present invention. In other embodiments, activators of AC such as calmodulin and divalent cations may also be included in the compositions and methods of the present invention.

Compositions of the Present Invention

In some embodiments of the present invention, a composition comprising components for the conversion of AMP to ADP, e.g., PAP and polyphosphate, is provided. In other embodiments, the composition for converting AMP to ADP may also contain components for removing or depleting ATP present in a sample, e.g., AC and pyrophosphatase. In some embodiments of the present invention, a composition comprising components for converting ADP to ATP, e.g., AK and polyphosphate, is provided. In some embodiments, the composition for converting ADP to ATP further comprises components for the detection of the ATP generated, e.g., luciferin and luciferase. In other embodiments, the composition of the present invention contains: 1) a luciferase and 2) one or more ADP to ATP converting enzymes. In some embodiments, the composition of the present invention optionally contains an adenylate cyclase inhibitor, a substrate for the ADP converting enzyme, a substrate for luciferase, an enzyme that converts AMP to ADP, an inhibitor for the AMP to ADP converting enzymes, and/or a substrate for the AMP to ADP converting enzyme. In some embodiments, the composition of the present invention contains: 1) adenylate cyclase, 2) a pyrophosphatase, 3) one or more inhibitors of an enzymatic reaction involving an enzyme such as aminoacyl tRNA synthetase (ARS), DNA methyltransferases, protein methyltransferases, small molecule methyltransferases, DNA ligases, phosphodiesterases (PDEs), ubiquitin ligases, ubiquitin activating and conjugating enzymes, etc. In some embodiments, the composition contains enzymes such as S-adenosyl homocysteine hydrolases, adenosine kinases, PAP, AK, luciferase, etc. In some embodiments, the composition optionally contains an activator of adenylate cyclase. In some embodiment, an ATP detection reagent, e.g., one containing luciferase and luciferin, is provided. In some embodiments, the luciferase and luciferin is lyophilized. In some embodiments, the ATP detection reagent may also contain excipients for lyophilization, a protein, e.g., luciferase, stabilizer, magnesium or alternative cation, and a magnesium chelator or alternative cation chelator.

In some embodiments, the compositions of the present invention may contain a compound to inhibit PAP or AC which may be added before the addition of ADP to ATP conversion reagent and ATP detection reagent, e.g., adenylate kinase (AK)/luciferin-luciferase reagent. In some embodiments, the composition may also contain a pyrophosphatase to breakdown pyrophosphate which might affect the luciferase activity in the luciferin-luciferase. In some embodiments, the composition of the present invention contains all components in a single solution, composition or reagent, e.g., a homogeneous assay. In some embodiments, the composition can be tested for the presence of AMP or AMP generating reactions using a control that is devoid of AMP.

In some embodiments, the compositions of the present invention may further comprise a buffer, a divalent cation metal chelator(s), magnesium or alternative cation, a defoaming agent, and an enzyme stabilizer e.g., THESIT. In some embodiments, the components of the compositions of the present invention may be supplied as separate components that are admixed shortly before use. In other embodiments, the different components may comprise subsets of these parts and may be combined in any way that either facilitates the application of the invention or prolongs storage life of the composition of the present invention.

Kit Components:

In some embodiments, the kit of the present invention comprises 1) an AMP to ADP conversion composition containing PAP and polyphosphate and 2) an ADP to ATP conversion composition containing AK and polyphosphate. In some embodiments, the AMP to ADP conversion reagent further contains components, e.g., AC and pyrophosphatase, to remove or deplete ATP and the AC-generated pyrophosphate. In some embodiments, the kit further comprises an ATP detection reagent, e.g., one comprising luciferin and luciferase. In some embodiments, the kits of the present invention may further include reagents in separate containers that facilitate the execution of an additional assay test(s) such as one to determine viability, cytotoxicity, or cell proliferation. In some embodiments, ATP and/or AMP may be supplied in the kit so a standard curve(s) may be determined or to be used as internal controls. In some embodiments, substances that are known to be inhibitors or activators of reactions generating AMP can be included for use as additional controls. In other embodiments, the kits may contain multiwall plates and/or one or more AMP generating enzymes, e.g., PDEs, ligases, ARS, methyltransferases, protein isoaspartate methyltransferases, adenylate cyclases, and/or AMP to ADP and ADP to ATP converting enzymes. In some embodiments, the kits of the present invention may optionally include substrates for the ligases, methyltransferases, PDEs, ARS, etc., buffers, and/or inhibitors and/or activators of the adenylate cyclase.

In some embodiments, the kit of the present invention comprises 1) SAM (S-Adenosyl-Methionine), 2) SAH (S-Adenosyl-Homocysteine), 3) SAH to ADP conversion (via AMP) composition comprising PAP, SAH-Hydrolase and Adenosine Kinase, 4) ADP to ATP conversion composition comprising Adenylate kinase (Myokinase), and 5) ATP detection reagent, e.g., comprising luciferin and luciferase. In some embodiments, the kits of the present invention may contain a compound to inhibit Adenosine kinase, PAP or AC which may be added before the addition of ADP to ATP conversion reagent and ATP detection reagent, e.g., adenylate kinase (AK)/luciferin-luciferase reagent. In some embodiments, the kit may also contain a pyrophosphatase to breakdown pyrophosphate which might affect the luciferase activity in the luciferin-luciferase. In some embodiments, the kit of the present invention contains all components, compositions or reagents in a single solution, composition or reagent, e.g., a homogeneous assay kit. In some embodiments, the kit compositions can be tested for the presence of AMP or AMP generating reactions using a control that is devoid of AMP.

In some embodiments, the reagents included in the kits of the present invention can be supplied in containers of any sort such as the life of the different components are preserved and are not adsorbed or altered by the materials of the container.

### EXAMPLES

To create a robust assay for determining AMP concentrations and/or monitoring AMP formation as the universal product of many biochemical reactions, the AMP generated is converted to ADP using PAP while simultaneously depleting ATP if it is the substrate utilized to generate AMP. The depletion of ATP is carried out using a combination of adenylate cyclase and pyrophosphatase. The ADP produced from addition of PAP is converted to ATP using adenylate kinase (AK) while simultaneously converting the ATP generated into a luminescent signal, i.e., luminescence using an ATP detection reagent, e.g., a luciferin-luciferase reaction. The bioluminescent reaction has sufficient sensitivity and steady signal for large batch of plates.

Materials

Myokinase (AK) from rabbit skeletal muscle (Sigma Catalog number M3003)

Pyruvate kinase from rabbit skeletal muscle (Sigma Catalog number P9136)

Phosphoenolpyruvate (Sigma Cat #7127)

Creatine phosphokinase from bovine heart (Sigma Catalog number C7886)

Creatine phosphokinase from rabbit muscle (Sigma Catalog number C3755

Adenylate Cyclase (AC) was a recombinant fragment of B. pertussis toxin that contains the active AC portion and demonstrated activity using ATP as substrate. It was obtained from Promega Corp.

AMP 10 mM (Sigma cat #A1752)

Sodium hexametaphosphate or called polyphosphate hereafter (Sigma Cat #P8510)

AMP Glo Reagent I (ATP depletion/AMP to ADP Conversion Reagent): 80 mM Tris pH 7.5, 10 U/ml calmodulin, 2 U/ml pyrophosphatase, 0.1 mg/ml Prionex, 60 U/ml HQ-tagged AC, 10 mM MgCl2, 8 ug/ml HQ tagged-PAP and 40 uM polyphosphate

AMP Glo Reagent II (ADP to ATP Conversion Reagent): 2 KU/ml of AK, 4 mM polyphosphate, 3.2 mM Ammonium sulfate pH 6.0, and 1 mM EDTA.

AMP Detection Reagent: contains 10 μl of AMP Glo reagent II in 1 ml of Kinase-Glo® reagent

Kinase Glo Reagent (Promega Corp): Mix Kinase-Glo substrate and Kinase-Glo® Buffer, DNA or protein methyltransferases substrate (S-adenosylmethionine) (Promega)

S-adenosylhomocysteine hydrolase (Promega)

Adenosine kinase to convert the enzyme reaction product S-adenosylhomocysteine (SAH) to adenosine and to convert adenosine to AMP. (Promega)

### Methods

Cloning and Expression of Polyphosphate-AMP Phosphotransferase (PAP):

Genomic DNA of Acinetobacter johnsonii 210A was isolated from a bacterial culture, purified, and solubilized in distilled sterilized water. PCR was performed in a reaction containing the primers 5′-AAGTTTAAACTTAACGCCCGCTTTGGTTTA-3′ (SEQ. ID 1) and 5′-AAGCGATCGCACGGAACTCGCTATCACAAA-3′ (SEQ. ID. 2), a nucleotide mix and Taq DNA polymerase using the isolated genomic DNA as a template. The PCR fragments were purified and cloned into pGEM-T® vector (Promega Corp.), and the recombinant plasmid transformed into JM109 cells and grown on LB plates containing appropriate antibiotic. Well-grown bacterial colonies were selected to grow in culture for plasmid isolation and purification. Plasmid DNA was verified via restriction enzyme digestion. DNA was sequenced using the University of Iowa facility to verify the correct PAP sequence was cloned. PAP DNA was then subcloned into the pFN6K (HQ) Flexi® Expression Vector (Promega Corp.) and transformed into JM 109 growing in LB medium containing kanamycin. Plasmids were isolated and digested using restriction enzymes to verify the correct size of the DNA. BL21 (DE3) cells were transformed using the expression vector and grown in LB culture containing kanamycin to an OD₆₀₀ 0.4. The bacterial culture was then induced with IPTG (0.1 mM) and cultured for an additional 2 hrs. before lysis using Fast Break Lysis Buffer (Promega Corp.), and the size (55 kDa) verified. Large scale bacterial culture was made, and the bacteria induced and lysed as described above for the small scale culture. PAP enzyme was purified from the cell lysate using HisLink resin (Promega Corp) and eluted using 500 mM imidazole after washing with 350 mM Imidazole to remove extraneous proteins. The size of the purified enzyme was verified via SDS-PAGE. Activity was confirmed using AMP conversion to ADP, and HPLC to verify the generation of ADP and consumption of AMP substrate.

Activity Assay for PAP:

A standard reaction mixture containing Tris-HCl pH 8.0, 40 mM (NH₄)₂(SO₄), 4 mM MgCl₂, 10 μM AMP and 30 μM polyphosphate, whose average chain length is approximately 750 phosphate residues, was made. The reaction was initiated by the addition of PAP and performed at 37° C. The ADP formed was quantified using HPLC and known AMP, ADP, and ATP standards. Only the product ADP and the remaining AMP were identified on the chromatogram. One unit of PAP is defined as the amount of enzyme producing one micromole of ADP per minute.

Adenylate Cyclase Assay

Activity of various adenylyl cyclases (ACs) was measured at 30° C. for 30 minutes in the presence of 60 mM Tris pH 7.5, 10 mM MgCl₂, 125 nM calmodulin and variable ATP concentrations. Except for those experiments related to AC titration, 100 ng of the AC was used. When used, calmodulin antagonists were prepared according to the manufacturer's recommendations and were added directly to the AC reaction when direct inhibition was assessed or to the reaction converting ADP to ATP to assess AC inhibition during ATP formation

AMP Detection Assay

Testing samples containing AMP for AMP concentrations will be dependent on whether the sample contains ATP. If the sample contains ATP, depending on the volume of the reactions and the concentration of ATP, the sample should be treated with sufficient volume and concentration of reagent that contains adenylate cyclase, pyrophosphatase, magnesium, calmodulin, Tris or HEPES buffer pH 7.5, sufficient amount of PAP enzyme (25 ng/25 μL reaction), and polyphosphate (40 μM), e.g., AMP to ADP conversion reagent (AMP Glo Reagent I). The reaction is carried out at room temperature, or any other temperature of choice such as 25, 30, 37, 40° C., etc., for sufficient time to ensure the completion of ATP conversion to cAMP and simultaneous conversion of AMP to ADP. Suitably at least 90%, or at least 91% or at least 92%, or at least 93%, or at least 94%, or at least 95%, or at least 96%, or at least 97%, or at least 98%, or at least 99%, or at least 99.9% of the ATP in the original solution is converted by the AC. Furthermore, suitably at least 90%, or at least 91% or at least 92%, or at least 93%, or at least 94%, or at least 95%, or at least 96%, or at least 97%, or at least 98%, or at least 99%, or at least 99.9% of the AMP in the original solution is converted by the PAP. For the conversion of ADP to ATP while simultaneously converting the ATP into luminescence, an addition of a AMP detection reagent containing myokinase (AK, 1 U/50 μl detection reagent), polyphosphate (40 μM), magnesium chloride (10 mM) or other divalent cations, luciferin, and luciferase and other components can be used. The amount of luminescence generated is proportional to the amount of AMP present in the sample. Alternatively, the conversion of ADP to ATP can be performed separately using a reagent containing myokinase (AK, 1 U/50 μl detection reagent), polyphosphate (40 μM), magnesium chloride (10 mM) or other divalent cations, e.g., ADP to ATP conversion reagent (AMP Glo Reagent II). The ATP can then be measured by the addition of an ATP detection reagent, e.g., a luciferin-luciferase assay reagent, e.g., the Kinase-Glo assay reagent (Promega Corp.). If ATP is not present in the first reaction such as in PDE assays, the removal of ATP is not relevant, and thus conversion of AMP to ADP is directly performed using a reagent that contains PAP, polyphosphate, magnesium, e.g., MgCl₂, and a buffer such as Tris or HEPES pH 7.5. Other pH values such as 7.0, 8.0, and 9.0 or any pH in between can be used in the compositions of the present invention. The ADP formed in the last step is converted to ATP as described above, and the ATP to luminescence using an ATP detection reagent, e.g., a luciferin-luciferase reagent, e.g., Kinase-Glo (Promega Corp.) as described above.

### Example 1

### AMP Detection Assay

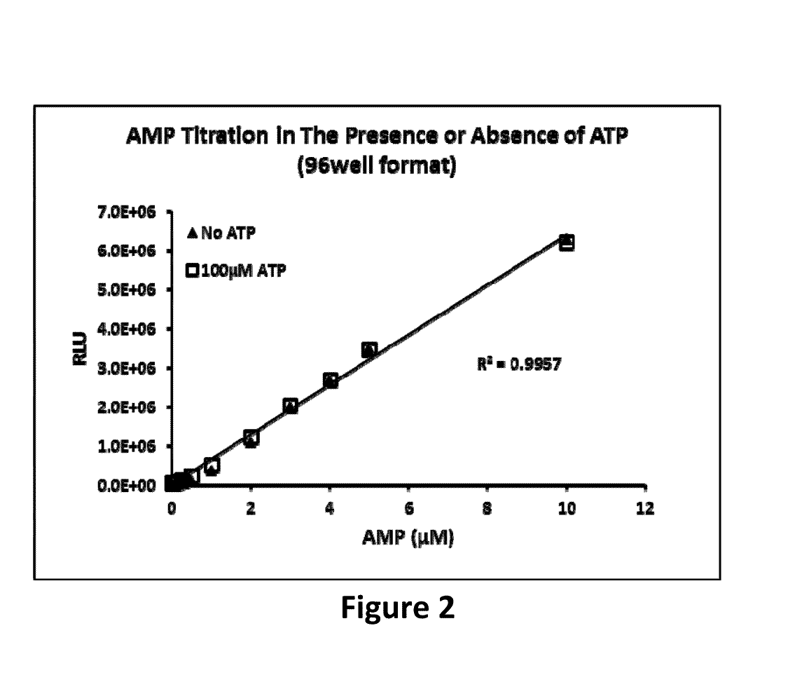

The AMP detection assay is performed generally in two steps as follows. In this example, the AMP titration was performed in 25 μl containing Reaction buffer A (40 mM Tris-HCl, pH 7.5, 20 mM MgCl₂, and 0.1 mg/ml BSA) in the presence or absence of 100 μM ATP. 250 of AMP-Glo Reagent I was added to the AMP samples and the mixture was incubated for 60 min at Room Temperature (23° C.). To detect AMP, 500 of AMP Detection Reagent (100 of AMP-Glo Reagent II in 1 ml of Kinase-Glo® One Solution) was added and the mixture was incubated for 60 min at Room Temperature (23° C.) before luminescence was read in a luminometer. The AMP titration described in FIG. 2 was performed in 96well plates (Corning Costar ®, cat #3912).

### Example 2

### Ubiqitinating Enzyme System

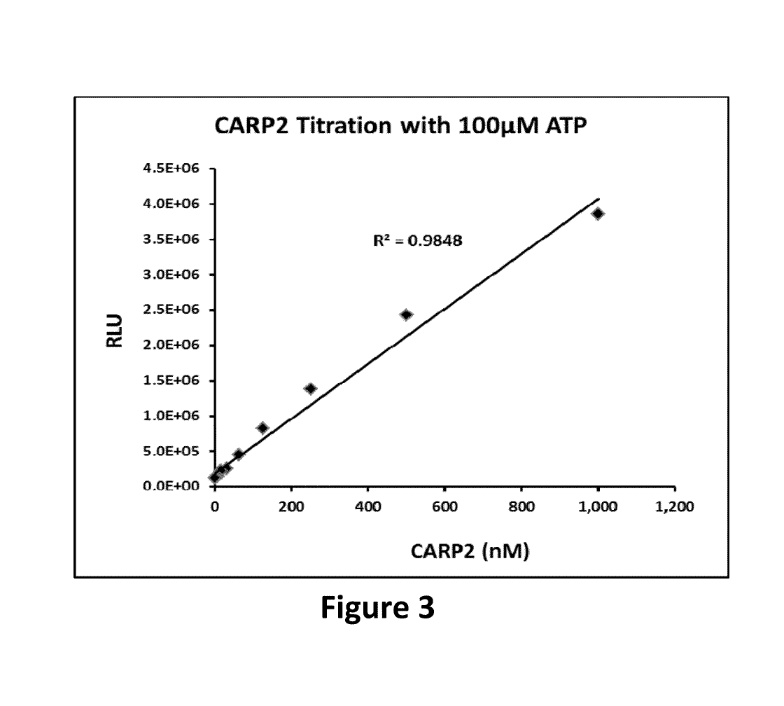

Reaction with an ubiquitinating enzyme or an enzyme involved in an ubiquitinating enzyme system does include the use of ATP as substrate. The method of the present invention was used to assay representative ubiquitinating enzymes including, but not limited to, Ube1 (E1), UbcH5c (E2), CARP2 (E3), and ubiquitin was used as a substrate. The enzymes were purchased as a complete kit (E3LITE customizable Ubiquitin Ligase Kit). Each enzyme was titrated separately and together, and the reaction performed in the E3 Ubiquitin Reaction Buffer (Reaction Buffer A supplemented with 0.2 mM DTT). AMP was converted using AMP Glo Reagent I followed by the conversion of ADP to ATP and detection of ATP using the AMP Detection Solution. Briefly, 5 ul of serially diluted. E3-ligase (CARP2; 20x) in E3 Ubiquitin Reaction Buffer was added to wells of a 384-well plate. The CARP2 reaction was started by adding 5 μl of a mixture containing E3 Ubiquitin Reaction Buffer, 100 μM ATP, 0.15 μM ubiquitin E1 activating enzyme, 0.6 μM ubiquitin E2 conjugating enzyme, and 40 μM recombinant Human ubiquitin. After incubation of 120 minutes at 23° C., 100 of the AMP to ADP conversion reagent was added, mixed for 2 minutes on an orbital shaker, and then incubated at room temperature for 60 minutes. To the samples, 20 μl of AMP Detection Reagent was added, and the samples were incubated at room temperature for 60 minutes. Luminescence was then detected on a luminometer (FIG. 3). It was found that AMP generated in the reaction was proportional to the ubiquitination, conjugation and/or ligase enzyme activity. No activity was found when ubiquitin was not present. Thus, the method of the present invention can be used to screen for compounds that alter the activity of the all enzymes involved in ubiquitination or any of the enzymes involved in an ubiquitating enzyme system.

### Example 3

### cAMP Phosphodiesterases (PDEs):

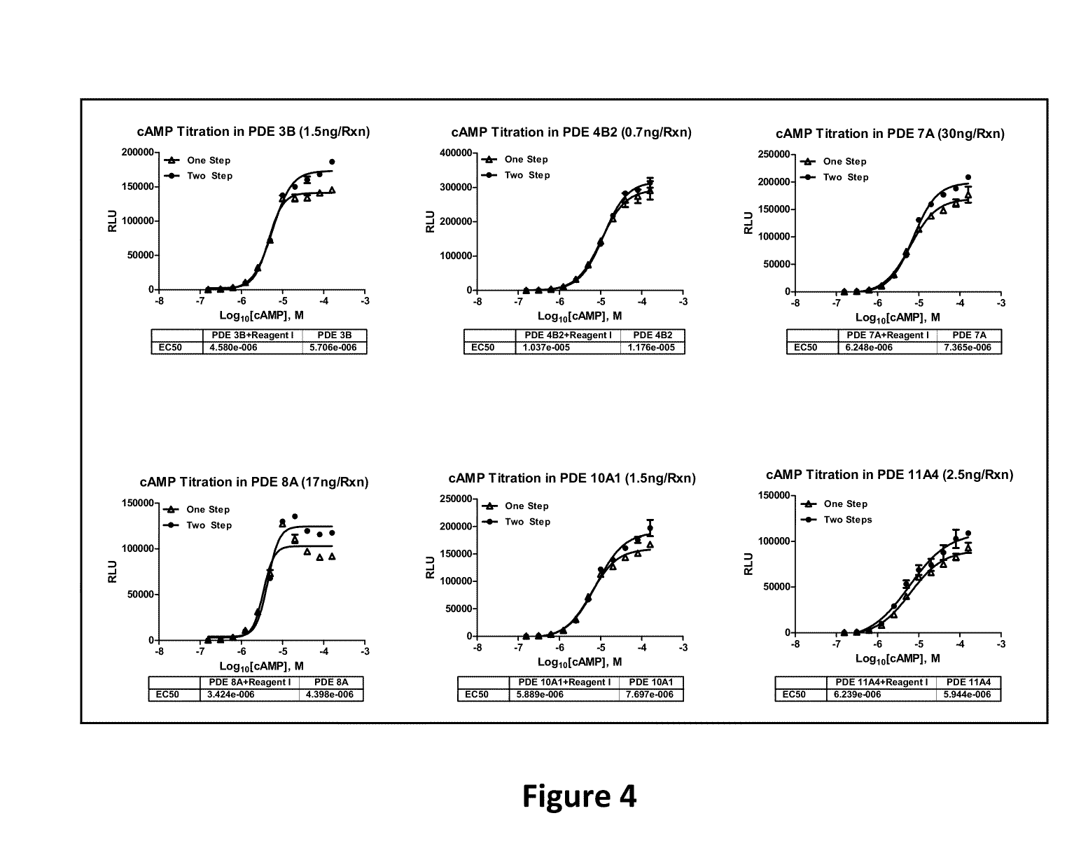

PDE enzymes do not use ATP as substrate, but instead use cAMP. In the method of the present invention, reactions with PDE enzymes, including but not limited to PDE 4, PDE 1, 2, 3, PDE 10A and PDE 11, were carried out at concentrations up to 100 μM cAMP, and the amount of luminescence generated was proportional to substrate concentration until saturation was reached and was proportional to the amount of enzyme within the linear range of the reaction. AMP in the samples was converted to ADP using a AMP-Glo Reagent I supplied with Isobutylmethylxanthine (IBMX). IBMX is known to inhibit most of PDEs and thus it terminates the PDE reaction. Its inclusion in the AMP Glo reagent should result in termination of PDE reaction and conversion of AMP produced into ADP. The ADP generated was then converted to ATP, and the ATP detected, using the AMP Detection Reagent. Briefly, cAMP titration with cAMP specific PDEs (amounts indicated on figures) was performed in a reaction buffer contains 40 mM Tris-HCl, pH 7.5, 10 mM MgCl₂, and 0.1 mg/ml BSA. PDE reactions were carried out in 5 μl for 60 min at 23° C. After incubation, 5 ul of the AMP to ADP conversion reagent supplied with 500 μM IBMX was added, mixed for 2 minutes on an orbital shaker and then incubated at room temperature for 60 minutes. To the samples, 10 ul of AMP Detection Reagent was added, and the samples again incubated at room temperature for 60 minutes. Luminescence was then detected on a luminometer (FIG. 4). The PDE reaction and the AMP to ADP conversion can be performed in one step by mixing the PDE, cAMP and the AMP-Glo Reagent I in 10 μl reaction and incubating at room temperature for 60 minutes before adding the 10 μl of AMP detection Reagent. The reaction was performed by in 384 well low volume plates (Corning Costar® cat #3674).

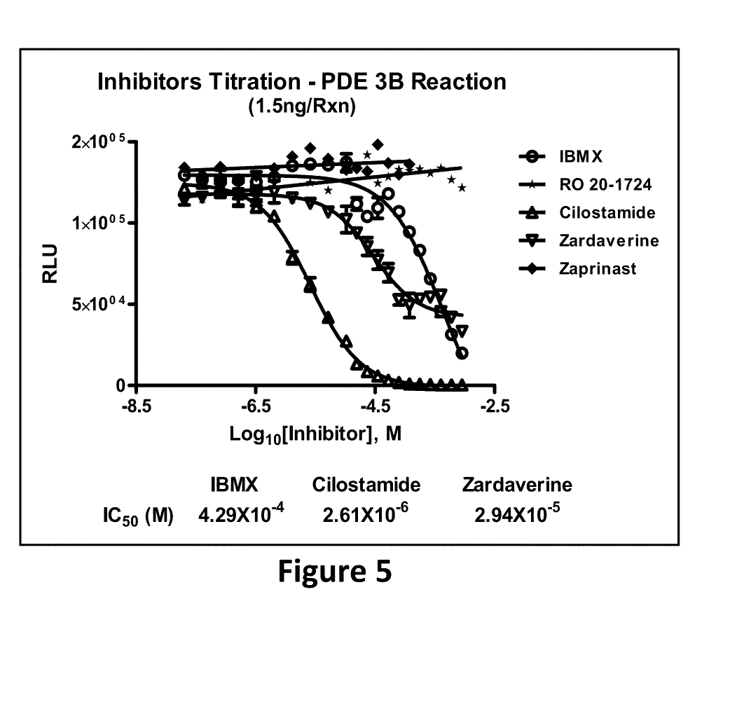

Reactions including different PDE 3B inhibitors were also performed as described above, and the IC50 concentration of inhibitors obtained with the method of the present invention was similar to that reported in the literature (1.5-2.0 μM) (FIG. 5). The assay also showed very minimal false hits when screened against 1280 compounds of the LOPAC library, and it produced high Z′ value confirming its robustness.

### Example 4

### Bacterial and Eukaryotic DNA Ligases

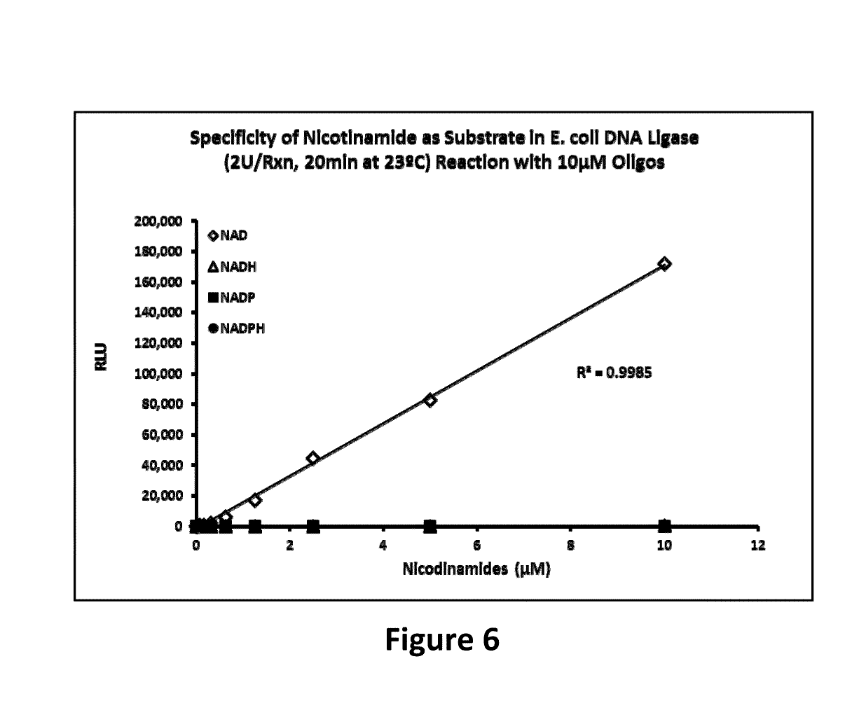

DNA ligases use NAD (bacterial) or ATP as substrate (viral and eukaryotic), but both enzymes generate AMP as one of the products. DNA ligation was demonstrated using E. Coli DNA ligase and synthetic oligos or lamda DNA Hind III fragments and in the presence of NAD (100 μM). E. coli DNA ligase reaction was performed in buffer containing 25 mM Tris-HCl, pH 8.0, 5 mM MgCl₂, 10 mM (NH₄)₂SO₄, 1 mM EDTA, and 0.1 mg/ml BSA supplemented with different amounts of Nicotinamides (NAD, NADH, NADP and NADPH) 10 μM Oligos using 384 well plate. The E. coli DNA ligase reaction was performed using 2 U/reaction in 5 μl volume and the reaction was incubated for 20 min at 23° C., followed by addition of 5 μl of Reagent I for 60 min at 23° C. After Reagent I reaction, 10 μl of AMP Detection Solution was added and the luminescence was read after 60 min at 23° C. The results show that E. coli DNA ligase is dependent on NAD specifically as nicotinamide co-factor (FIG. 6).

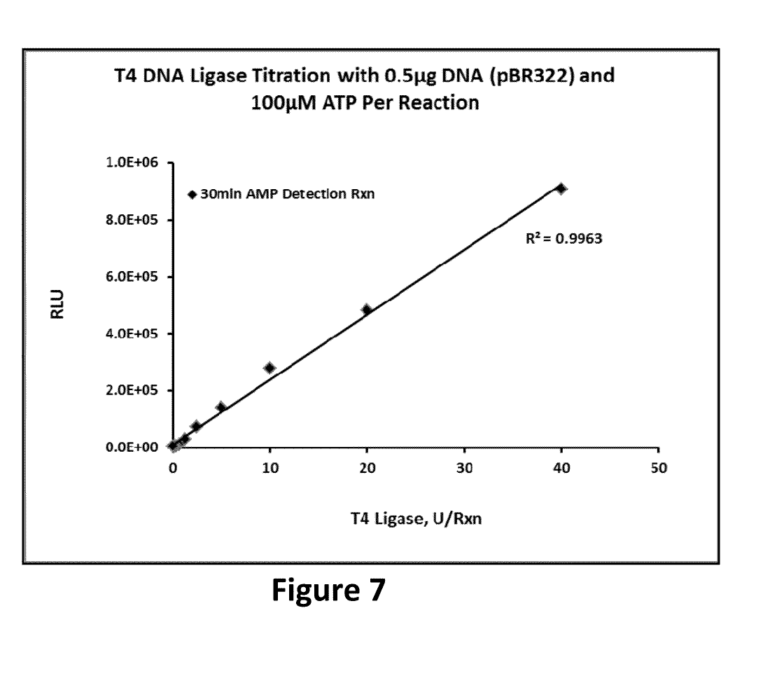

Similar assay conditions as described above were used to detect T4 DNA ligase (Promega) activity using an EcoRI-linearized vector (pBR322). T4 DNA ligase titration was carried out in a buffer contains 30 mM Tris-HCl, pH 8.0, 10 mM MgCl₂, 10 mM DTT, 100 μM ATP, in the presence of 0.5 μg pBR322 vector that was pretreated with EcoR1 for 60 min. T4 DNA ligase reaction was performed in 10 μl reaction for 30 min at 23° C., then added 10 μl of Reagent I for another 60 min at 23° C. After Reagent I reaction, 20 μl of AMP Detection Reagent was added and the luminescence was read after 60 min at 23° C. (FIG. 7).

### Example 5

### AMP Determination in Cellular and Tissue Extracts

The method of the present invention is also used to determine the presence and/or amount of AMP in tissue extracts. After removal of any ATP present in the sample using the AMP Glo Reagent I, which also converted the AMP present to ADP, the ADP was converted to ATP, and the ATP detected using the AMP Detection Solution. The samples are then tested for conversion of AMP alone (containing PAP and AK) are compared to those which contained AK only and the difference was expressed as AMP.

### Example 6

### Detection or Quantitation of Methyltransferases via AMP Detection

Methyltransferases, e.g., DNA or protein methyltransferases, are used to carry out methylation of DNA or protein using S-adenosylmethionine (SAM) as substrate. Since S-adenosylmethionine (SAM) is the universal substrate, and S-adenosylhomocysteine (SAH) is the universal product for methyltransferases, the method of the present invention would involve the conversion of SAH to adenosine using SAH hydrolase, and the conversion of adenosine to AMP using adenosine kinase. The amount of AMP produced would be detected and/or determined using the method and compositions described herein.

Quantitation of the Different Methyltransferase Activities.

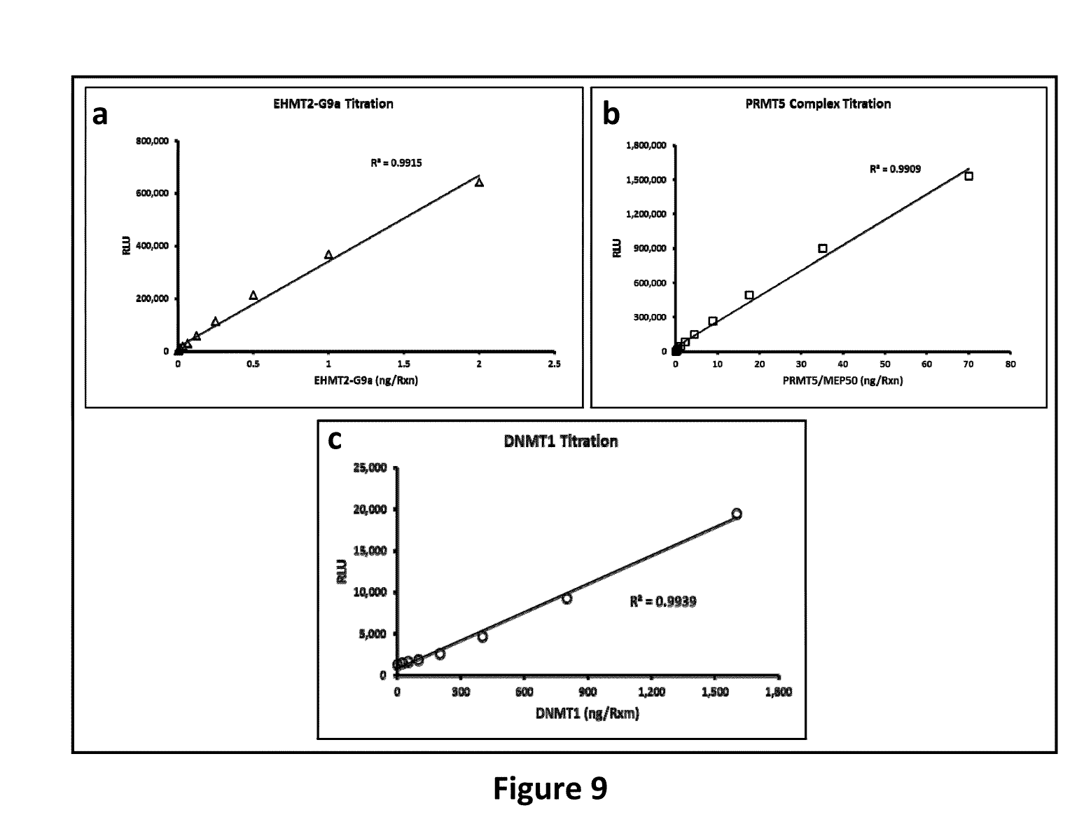

Methyltransferase reactions were performed in a reaction buffer (20 mM Tri-HCl, pH 8.0, 50 mM NaCl, 1 mM EDTA, 3 mM MgCl2, 1 mM DTT, and 0.1 mg/ml BSA) in the presence of different amounts of enzyme and the following substrate/enzyme combinations: EHMT2-G9a with 50 μM SAM and 50 μM H3 peptide (1-25), PRMT5 complex with 50 μM SAM and 50 μM H4 (1-20) peptide, and DNMT1 with 10 μM SAM and 0.41 M DNA oligos (FIG. 9abc). All methyltransferase titration assays were carried out in 5 μl reaction containing also the conversion enzymes SAH-Hydrolase and Adenosine Kinase with 25 μM dGTP for 120 min at 37° C., then 5 μl of Reagent I was added for another 60 min at 23° C. After Reagent I reaction, 20 μl of AMP Detection Reagent was added and the luminescence was read after 60 min at 23° C. (FIG. 9).

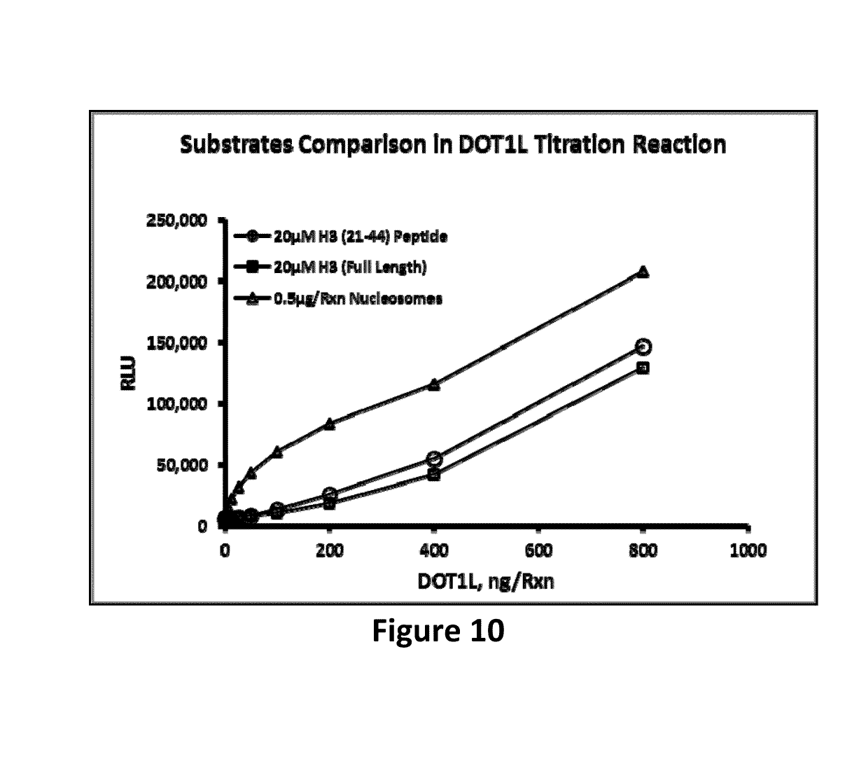

The DOT1L titration reaction with different substrates was performed in a reaction buffer (20 mM Tri-HCl, pH 8.0, 50 mM NaCl, 1 mM EDTA, 3 mM MgCl2, 1 mM DTT, and 0.1 mg/ml BSA) in the presence of 20 μM SAM and either 20 μM H3 (21-44) peptide, Histone H3 full length protein, or Nucleosomes. Similarly to the methyltransferase assay above, the DOT assay was carried out in 5 μl reaction containing also the conversion enzymes SAH-Hydrolase and Adenosine Kinase with 25 μM dGTP for 120 min at 37° C., then 5 μl of Reagent I was added for another 60 min at 23° C. After Reagent I reaction, 20 μl of AMP Detection Reagent was added and the luminescence was read after 60 min at 23° C. (FIG. 10).

### Example 7

### Detection of Deamidation of Asparagine or Rearrangement of Aspartic Acid Residues in a Protein

During long term storage and handling of proteins, a deamidation of asparagine residues and rearrangement of aspartic acid residues occur frequently at different levels resulting in their conversion to isoaspartate. In the biologics field it is very important to monitor the level of non-enzymatic deamidation of therapeutic proteins e.g. antibodies. To detect isoaspartate level on a protein, Protein Isoaspartyl Methyltransferase (PIMT) can be used to specifically detect the presence of isoaspartic acid residues in a target protein. PIMT transfers a methyl group from S-adenosyl-L-methionine (SAM) to isoaspartic acid, generating S-adenosyl homocysteine (SAH) that can be detected by the method and compositions of the present invention.

### Example 8

### Aminoacyl tRNA-Synthetase (ARS) Assay

The method and compositions of the present invention could be also used to monitor the activity of aminoacyl tRNA-synthetases (ARS) since ATP and other substrates are the components of the enzyme reaction, AMP is a product of this reaction, and the AMP generated from this reaction will be proportional to ARS activity.

Although this invention has been described in certain specific exemplary embodiments, many additional modifications and variations would be apparent to those skilled in the art in light of this disclosure. It is, therefore, to be understood that this invention may be practiced otherwise than as specifically described. Thus, the exemplary embodiments of the invention should be considered in all respects to be illustrative and not restrictive, and the scope of the invention to be determined by any claims supported by this application, and the equivalents thereof, rather than by the foregoing description.

1. A method of determining the amount of adenosine monophosphate (AMP) in a solution comprising:
i) converting substantially all AMP in the solution to adenosine diphosphate (ADP) using a first enzyme that is capable of converting AMP to ADP;
ii) converting the ADP in the solution adenosine triphosphate (ATP) using a second enzyme that is capable of converting ADP to ATP;
iii) after step (ii) determining the amount of the ATP produced in step (ii) using a bioluminescent reaction utilizing a luciferase enzyme and a substrate for the luciferase enzyme;
iv) using the amount of ATP produced to determine the amount of AMP present in the solution before step (i).

2. The method of claim 1 wherein, before step (i) a step of converting substantially all adenosine triphosphate (ATP) in the solution to cyclic adenosine monophosphate (cAMP) and pyrophosphate using adenylate cyclase (AC) is performed.

3. The method of claim 1 wherein the first enzyme is polyphosphate:AMP phosphotransferase (PAP).

4. The method of claim 3 wherein polyphosphate is added to the solution along with PAP.

5. The method of claim 1 wherein the second enzyme is adenylate kinase (AK).

6. The method of claim 1 wherein step (ii) is simultaneous to step (i).

7. The method of claim 1 wherein step (ii) is after step (i).

8. The method of claim 1 wherein before step (i) a step of converting cAMP in the solution to AMP using a phosphodiesterase (PDE) is performed.

9. The method of claim 1 wherein simultaneous to step (i) a step of converting cAMP in the solution to AMP using a phosphodiesterase (PDE) is performed

10. The method of claim 8 or 9 wherein the PDE is selected from the group consisting of PDE 1, PDE 3, PDE 4, PDE 7, PDE 10A, and PDE 11.

11. The method of claim 1 wherein before step (i) a step of converting ATP in the solution to AMP using a ubiquitinating enzyme and ubiquitin is performed.

12. The method of claim 11 wherein the ubiquitinating enzyme is selected from the group consisting of Ube1 (E1), UbcH5c (E2), and CARP2 (E3).

13. The method of claim 1 wherein before step (i) a step of converting ATP in the solution to AMP using a DNA ligase is performed.

14. The method of claim 13 wherein the DNA ligase is eukaryotic or viral DNA ligase.

15. The method of claim 1 wherein before step (i) a step of converting nicotinamide adenine dinucleotide (NAD+) in the solution to AMP using a DNA ligase is performed.

16. The method of claim 1 wherein simultaneous to step (i) a step of converting nicotinamide adenine dinucleotide (NAD+) in the solution to AMP using a DNA ligase is performed.

17. The method of claim 15 wherein the DNA ligase is E. coli NAD+ dependant DNA ligase.

18. The method of claim 1 wherein the following steps are conducted:
a) converting S-adenosyl methionine (SAM) in the solution to S-adenosylhomocysteine (SAH) using a methyltransferase;
b) converting the SAH to adenosine using an SAH hydrolase;
c) converting the adenosine to AMP using adenosine kinase.

19. The method of claim 18 wherein steps a), b) and c) are performed before step i)

20. The method of claim 18 wherein steps a), b) and c) are performed simultaneously to steps i) and ii).

21. The method of claim 18 wherein the methyltransferase is selected from the group consisting of histone-lysine N-methyltransferase, (DNA (cytosine-5)-methyltransferase, Protein Isoaspartyl Methyl Transferase and protein arginine methyltransferase.

22. The method of claim 1 wherein before step (i) a step of converting ATP in the solution to AMP using an aminoacyl tRNA synthetase is performed.

23. The method of claim 2 wherein the method further comprises removing substantially all pyrophosphate produced prior to steps (ii), (iii) and (iv).

24. The method of claim 2 further comprising the step of inhibiting adenylate cyclase prior to, (ii) or (iii) with a composition comprising an inhibitor.

25. The method of claim 2 wherein the adenylate cyclase is an active fragment of a full length bacterial adenylate cyclase.

26. The method of claim 2, wherein the adenylate cyclase is an active recombinant fragment of a bacterial adenylate cyclase.

27. The method of claim 2, wherein the adenylate cyclase is a bacterial adenylate cyclase.

28. The method of claim 2, wherein the bacterial adenylate cyclase is from Bortedella pertussis or Bacillus anthracis.

29. The method of claim 1 wherein the substrate for the luciferase enzyme is luciferin.

30. A kit for measuring the amount of AMP in solution comprising:
i) polyphosphate:AMP phosphotransferase (PAP);
ii) polyphosphate
iii) adenylate kinase (AK);
iv) a luciferase enzyme;
v) a substrate for the luciferase enzyme.

31. The kit of claim 30 further comprising adenylate cyclase (AC).

32. The kit of claim 31 further comprising pyrophosphatase (PPase),

33. The kit of claim 31 further comprising magnesium chloride.

34. The kit of claim 31 further comprising calmodulin.

35. The kit of claim 30 further comprising ATP and AMP.

36. The kit of claim 30 further comprising a phosphodiesterase (PDE).

37. The kit of claim 36 wherein the PDE is selected from the group consisting of PDE 1, PDE 3, PDE 4, PDE 7, PDE 10A, and PDE 11.

38. The kit of claim 36 further comprising isobutylmethylxanthine (IBMX).

39. The kit of claim 30 further comprising an ubiquitinating enzyme and ubiquitin.

40. The kit of claim 39 wherein the ubiquitinating enzyme is selected from the group consisting of Ube1 (E1), UbcH5c (E2), and CARP2 (E3).

41. The kit of claim 30 further comprising a DNA ligase.

42. The kit of claim 41 wherein the DNA ligase is E. coli DNA ligase.

43. The kit of claim 41 further comprising nicotinamide adenine dinucleotide (NAD+).

44. The kit of claim 43 wherein the DNA ligase is E. coli NAD+ dependant DNA ligase.

45. The kit of claim 30 further comprising a methyltransferase, an SAH hydrolase and adenosine kinase.

46. The kit of claim 45 wherein the methyltransferase is selected from the group consisting of histone-lysine N-methyltransferase, (DNA (cytosine-5)-methyltransferase, Protein Isoaspartate Methyl Transferase and protein arginine methyltransferase.

47. The kit of claim 30 further comprising an aminoacyl tRNA synthetase.


SEQUENCE LISTING (2 sequences)

SEQ ID NO: 1 - DNA, 30 bp, Artificial Sequence
  Synthetic oligonucleotide
aagtttaaacttaacgcccgctttggttta

SEQ ID NO: 2 - DNA, 30 bp, Artificial Sequence
  Synthetic oligonucleotide
aagcgatcgcacggaactcgctatcacaaa